(19) United States
(12) Patent Application Publication
(10) Pub. No.: US 2011/0101179 A1
(43) Pub. Date: May 5, 2011

(54) TV SUPPORT STRUCTURE WITH LATCHING MECHANISM

(76) Inventors: Brian D. Fritch, Stryker, OH (US); Terry W. Armey, Napoleon, OH (US); Douglas Paul Krieger, Archbold, OH (US); James W. Ballmer, Wauseon, OH (US)

(21) Appl. No.: 12/826,255

(22) Filed: Jun. 29, 2010

Related U.S. Application Data
(60) Provisional application No. 61/269,770, filed on Jun. 29, 2009.

(51) Int. Cl. F16M 11/08

(52) U.S. Cl. 248/125.7

(57) ABSTRACT

A T.V. support structure (100) includes a post support assembly (140). The post support assembly (140) includes a vertically disposed and hollow post (142) and a vertical support clamp assembly (144). A swivel bracket assembly (190) is positioned on top of the clamp assembly (144). The swivel assembly (190) includes a swivel bracket (192) which interconnects structure associated with a T.V. (102) to the post support assembly (140).

### CROSS-REFERENCE TO RELATED APPLICATIONS

This Application is based upon and claims priority of U.S. Provisional Patent Application Ser. No. 61/269,770 filed Jun. 29, 2009.

### STATEMENT REGARDING FEDERALLY SPONSORED RESEARCH OR DEVELOPMENT

Not Applicable.

### REFERENCE TO A MICROFISHE APPENDIX

Not Applicable.

### BACKGROUND OF THE INVENTION

1. Field of the Invention

The present invention relates to electrical apparatus support structures and, more particularly, to TV support structures and latch mechanisms for releasably supporting the structures.

2. Background Art

Many televisions (TV's), especially those that are more than several years old, have the disadvantage in that they are large and relatively bulky. As a result of their size and weight, such TV's were typically placed directly on a desk, TV console or other work surface. Although some TV's having a relatively bulky configuration have been used on support arms (such as in hospitals and the like), this option is not particularly practical in many situations. Such support arms are relatively expensive and require extensive and sophisticated hardware for mounting to a durable wall or other mounting structure.

Over the past several years, there has been a steady increase in the use of flat panel televisions as a replacement for conventional TV's. Flat panel TV's typically occupy less space and may be significantly lighter in weight than conventional TV's. As a result of their reduced weight, flat panel TV's and similar types of apparatus can be more easily supported above a desk or other work surfaces through the use of support arms or similar cantilevered structures. However, although such flat panel monitors are lighter than conventional TV's, many are still relatively heavy and require strong and durable support structures. Many of these support structures often include relatively large and rigid arm segments that are joined by complex durable joints. Although the joints provide a level of adjustability, they are often difficult to operate and also provide for a limited range of adjustability.

Many of the known support structures for flat panel TV's suffer from one or more other disadvantages. For example, for purposes of adjustment of height or distance from the floor for the flat panel monitor, a number of structures have notches or slots through which various types of key devices can be adjustably mounted, so as to provide for height or vertical adjustment at finite and discrete positions. Another issue can relate to how the weight of the supported TV or other appliance is distributed through the support structure. If the weight or forces exerted by the flat panel monitor on the support structure are in the form of cantilevered forces on joints, non-vertical components or similar structural elements, the forces (including torque on various supporting structure elements) can be significant and can require extremely strong and relatively expensive support elements.

Still further, many known support structures do not have any means for providing wire management. As is well known, and particularly with modern day TV's, a number of different cables and other types of wires can be connected to and around the TV monitor. Such cables and other wires may include not only conventional AC power, but also data interconnections to DVD's, speakers and other similar electronic equipment.

Still further, some known support structures permit the supported TV or other apparatus to be positioned only in one three-dimensional orientation. In this regard, it can be advantageous if there is a capability of at least some adjustment with respect to orientation.

In addition to the issues discussed in the immediately prior paragraphs, other issues arise with respect to support structures adapted for use with TVs or related electronic equipment. In particular, one issue which often arises relates to components associated with the structure for attachment of the structure to the TV. In a number of TV supporting structures, it is known to utilize connection means such as screws, nut/bolt combinations and the like, for connecting brackets which may be originally associated with the TV itself, to components of the supporting structures such as wall plates or the like. Problems associated with such attachment means include the difficulty and time involved in attaching and detaching the bracket and wall plate components. The difficulty is particularly exacerbated in situations where the supporting structure is positioned such that there is limited access between the TV and a wall, or other immovable or extremely heavy object. As an example, if the access between the TV and a wall is limited, it is extremely difficult to appropriately position screwdrivers, wrenches (even including ratchet-type devices) or the like to use the connection means for attachment and detachment.

With respect to the prior art, Lee, U.S. Pat. No. 7,195,214 issued Mar. 27, 2007 discloses a stand for a display which is expressly directed to the capability of supporting the display in a manner so that it can be swiveled and elevated. Lee, et al. also disclose their invention as being particularly directed to relatively heavy and large-sized displays. One embodiment of the Lee, et al. stand is disclosed in FIGS. 1, 2, 3A and 3B of the patent. Therein, and with reference to the numerical references in the patent, a first embodiment of the display stand includes a base 100, vertically oriented supporting case 200 and a mounting bracket 500. A supporting member 400 is enclosed within the supporting case 200. The stand also includes a display mounting part 700, which is coupled to the mounting bracket 500.

Lee, et al. further disclose the base 100 of the stand as including a base plate 110, seating part 120 and engaging hole 130. An extending part 111 is located on a first end of the base plate 110 and widens a contact area of the base 100 for purposes of stability. Covers 113, 115 are used to cover opposing sides of the base plate 110. The seating part 120 includes a series of engaging holes 130, for seating the supporting case 200.

The supporting case 200 includes a trunk part 210 and supporting guide 220. The supporting trunk part 210 is preferably circular, with a rotating case 300 seated on the supporting case 200, and providing for a rotation or swivel motion of the interconnected display. The supporting case 200 can include a supporting bracket 230, with bracket covers 240 and 250. The case 200 also includes a seating flange 231, on which the supporting member 400 is seated. A first hole 233 engages a supporting bracket 230 with the trunk part 210. A second part 235 engages the supporting bracket with the seating part 120 of the base 100.

The trunk part 310 of the rotating case 300 includes a hollow opening through which the supporting member 400 is received. The trunk part 310 is installed onto an upper part of the case 200, and rotates thereon. A projection part 320 protrudes from an inner surface of the trunk part 310, and maintains predetermined separation from an outer face of the supporting case 200. A bracket-inserting opening 330 is located on the first end of the trunk part 310, and receives the rotating case 300 for engaging the mounting bracket 500.

The rotating case 300 also includes an inserting guide 340, with an external diameter corresponding to the internal diameter of the trunk part 310. The internal diameter of the inserting guide 340 corresponds to an external diameter of the supporting trunk part 210. Accordingly, the lower part of the trunk part 310 is inserted on the upper part of the supporting trunk part 210.

The mounting bracket 500 includes an engaging part 510, mounting face side 520 and mounting hole 530. The engaging part 510 engages the bracket engaging part 420 located on one end of the supporting shaft 410 of the support member 400. The mounting bracket 500 also includes an inserting part 550. Part 550 is in the form of a boss of predetermined thickness, corresponding to the bracket inserting opening 330 of the rotating case 300. The boss is positioned between the engaging part 510 and the mounting face 520, and extends away from the first end of the mounting bracket 500. The inserting part 550 can be inserted into the bracket inserting opening 330.

The display can be mounted to a display mounting part 700, using an engaging hole 750. The display can then be rotated in either direction, with the display mounting part 700 engaging the mounting bracket, which in turn engages a cylinder part 600 and the rotating case 300. Forces applied to the side of the display are transferred to the rotating case 300, and result in rotation about the axis of the cylinder part 600. Rotation continues until a stopper is encountered on either side of a recess 213. Correspondingly, elevation of the display can be changed by applying a force of predetermined magnitude to a top or bottom of the display. The force is transferred from the display to the mounting part 700, and in turn to the mounting bracket 500 and the cylinder part 600. The force will compress the cylinder part 600, sliding the cylinder 620 into the cylinder cover 610, thereby changing the elevation.

McGreevy, U.S. Patent Application Publication No. 2007/0252919, published Nov. 1, 2007, discloses a support system for a flat panel display. McGreevy describes providing a mounting device which can be adjusted in a variety of orientations, with means for adjustment allowing the user to remain in a viewing position. The support system as described includes a base, extendable mast, and a universally adjustable mounting device. McGreevy includes means for remotely controlling actuating devices, for purposes of adjustment of the display screen to a number of different adjustment orientations.

More specifically, and with reference to the numerals within the McGreevy drawings, a remotely controlled adjustable flat panel display support system 10 is described. The system 10 includes a base 12, mast 34, orientation apparatus 62, and a control system 126. The mast 34 of the system 10 includes a foundation column 36 and an extendable column 38, having a telescoping relationship with the foundation column 36. The mast 34 performs a function of supporting and elevating the display device to the desired height. The system 10 uses a linear mast actuator 40 for extending and retracting the extendable column 38.

The orientation apparatus 62 supports the flat panel display device 5 through a connection on its backside. The apparatus 62 can be mounted to the extendable column 38 through swivel knuckles 70. The knuckle apparatus provides for tilting motion. A swivel actuator 74 is used for providing motorized movement of a display screen.

Whalen et al, U.S. Patent Application Publication No. 2006/0284031, published Dec. 21, 2006, is also directed to a support system for a flat screen television. The Whalen et al support system is utilized in combination with a piece of furniture for providing support to the attached flat screen television.

In one embodiment, a support device 100 supports the flat screen television 180 above a surface 164 of a piece of furniture. The support device 100 includes a pedestal 110 with an upper support 130. The pedestal 110 includes a base 112, which transfers the weight of both the support and a television screen 180. The base 112 can be formed as a box-like shape in contact with the floor. Feet 113 can be connected beneath the base 112. A column 111 extends vertically upward from the base 112 adjacent the rear wall of the Furniture piece. An attachment plate 116 provides for connection of the column 111 to the rear wall of the furniture piece 160 at a point above the base 112.

An upper support includes a post 133 extending from the column 110 and vertically adjustable relative to the column. The post 133 is slidably received within the column 110. Spaced openings 119 are provided in both the column 110 and post 133 for alignment with pins, bolts or other fasteners. Spaced apart apertures 115, 135 and the column 110 and post 133 provide for ingress and egress of electrical cables routed through the column 110 and post 133.

A cantilevered arm 134 extends forwardly and upwardly from the adjustable post 133. The arm 134 includes a short vertical outer arm 136 secured to a screen mounting member 138. A series of spaced apart apertures 139 are formed in the screen mounting member 138, so that the mounting member can be universally mountable to a number of flat television screens.

MacLeod, U.S. Patent Application Publication No. 2003/0042373, published Mar. 6, 2003, describes an ergonomic positioning apparatus for computers and computer accessories. A structure is described having a vertical tube or cylinder supporting an adjustable cross-fitting, so that a sliding and rotational fit can be obtained. Cross-fitting slides are vertical relative to the cylinder, and rotate about the vertical member. A cantilevered arm member is also disclosed, extending across a cross-fitting and supporting a computer device and table payload. A pivoting huh is attached to the end of the arm.

Sweere, et al, U.S. Pat. No. 5,738,316, issued Apr. 14, 1998, discloses a vertical work center for positioning a computer monitor about vertical and horizontal axes. The work center includes a base, column connected to the base, bracket connected to the column, and a positionable arm having an upper arm assembly connected to the bracket and including gas springs connected between ends of the positionable arm. A tile/swivel adjustment is provided so as to be connected to a lower arm assembly end for supporting a caddy.

lsensee, et al, U.S. Pat. No. 6,490,981, issued Dec. 10, 2002, is directed to a support member disclosed as being useful for a table leg. The patent discloses internal wire management within the vertically disposed leg. Wire management within legs is also disclosed in Frattini, U.S. Pat. No. 6,389,988 issued May 21, 2002.

Anderson, U.S. Pat. No. 5,540,159, issued Jul. 30, 1996, discloses a television stand for supporting a set. The stand includes a planar top member to hold the set, and a first connector affixed to the bottom surface of the planar member at the midpoint of the member. The connector includes a flanged coupling having a coupled portion and a flanged end, with the flanged end attached to the bottom surface of the planar member. The coupling portion is cylindrical and attached to one end of a mating hollow shaft, with the shaft being of a predetermined length and extending from a first to a second connector. The second connector is a coupling mating with the other end of the shaft and affixed to a bracket. The bracket is a double-arm unit forming a right angle, with the bracket providing attachment of the support stand to a bed.

### BRIEF DESCRIPTION OF THE SEVERAL VIEWS OF THE DRAWING

The invention will now be described with respect to the drawings, in which:

FIG. 1 is a perspective view of a preferred embodiment of a TV support structure as adapted for use with a TV and secured to a furniture cabinet;

FIG. 2 is a rear-side perspective view of the TV support structure, TV and furniture cabinet shown in FIG. 1;

FIG. 3 is a left-side, front perspective view of the TV support structure. TV and furniture cabinet shown in FIG. 1;

FIG. 4 is a right-side, perspective view of the TV support structure, TV and furniture cabinet shown in FIG. 1;

FIG. 5 is a perspective and exploded view of components associated with a post support assembly of the TV support structure;

FIG. 6 is a side, elevation view of the assembly, with the TV and the furniture cabinet shown in phantom-line format;

FIG. 7 is an enlarged and perspective view of the swivel assembly, showing the support post, support clamp and swivel bracket;

FIG. 8 is an underside, perspective view looking upwardly, and showing the connections and connection brackets for connecting the TV support post to the furniture cabinet;

FIG. 9 is an overhead, plan view of the TV support structure, with the TV shown in phantom-line format and with the TV positioned in a forward orientation with zero degrees of swivel relative to an axis X shown in the drawing;

FIG. 10 is a plan view similar to HG. 9, but showing the TV, wall plate, connecting plate, and swivel bracket rotated in a horizontal plane through an angle A relative to the normal axis X;

FIG. 11 is an upper and right-side rear perspective view of a pair of TV mounting rails and a wall plate, with a release latch mechanism used to releasably attach the mounting rails to the wall plate;

FIG. 12 is an upper and right-side front perspective view of the TV mounting rails, wall plate, and latch mechanism shown in FIG. 11;

FIG. 13 is a partial and perspective view of one of the latch mechanisms in accordance with the preferred embodiment, and showing the mechanism in an open position relative to the wall plate and a corresponding one of the mounting rails;

FIG. 14 is a partial, side elevation view of the mechanism, mounting rail, and wall plate shown in FIG. 10, again with the mechanism in an open position;

FIG. 15 is a partial, perspective, and exploded view of one of the latch mechanism, the wall plate, and a corresponding mounting rail, showing the relative positioning of various components as coupled to the mounting rail and wall plate;

FIG. 16 is a partial, front, and exploded view (similar to FIG. 15), showing a corresponding mounting plate, wall plate, and individual components of the latch mechanism;

FIG. 17 is a partial, perspective view (similar to FIG. 13) of one of the latch mechanism, a corresponding mounting rail, and the support plate, with the mechanism in a closed position; and

FIG. 18 is a partial, side elevation view (similar to FIG. 14) of the mechanism shown in FIG. 14, and again showing the mechanism in a closed or latched position.

### DETAILED DESCRIPTION OF THE INVENTION

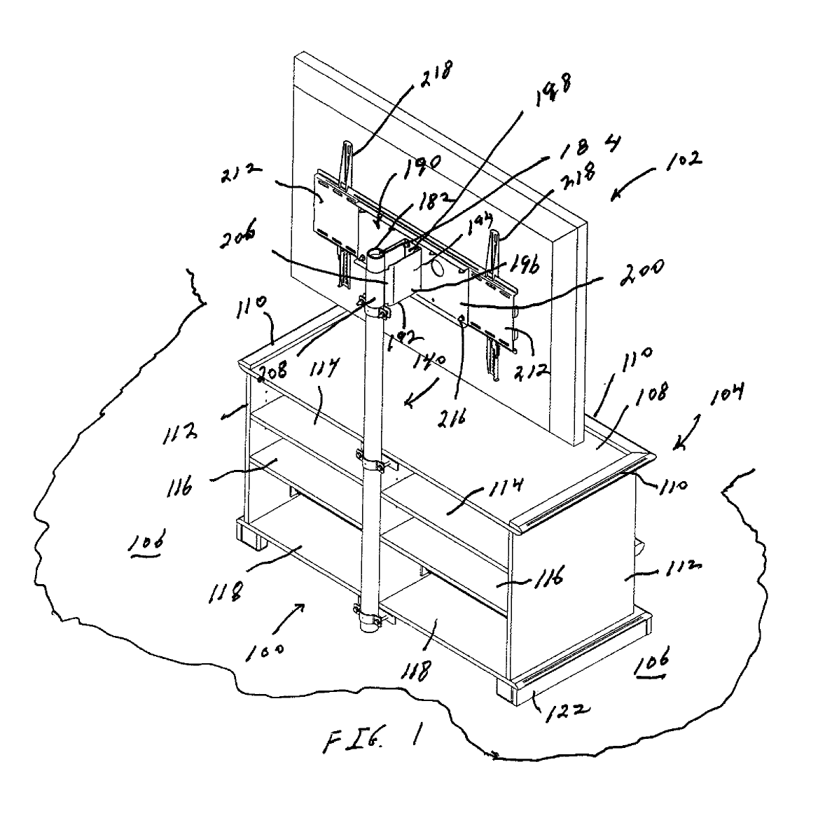

The principles of the invention are disclosed, by way of example, within a TV support structure 100 having a latch assembly, as described herein and illustrated in FIGS. 1-18. The TV support structure 100 and other support structures in accordance with the invention provide various advantageous features. In accordance with certain concepts of the invention, support structures in accordance with the invention include the capability of what can be characterized as an “infinite” vertical mounting of the television or other electronic apparatus to a stand portion of the support structure. Still further, in accordance with other concepts of the invention, the portion of the support structure which can be characterized as a post portion has the capability of resting on the floor. In this manner, the majority of the weight of the television or other electronic apparatus being supported is actually removed from the stand itself.

Still further, support structures in accordance with the invention can include the advantageous capability of internal cord management. In addition, TV support structures in accordance with the invention can include an advantageous feature of providing a “swivel” motion in a horizontal plane.

In addition to the foregoing, other concepts and principles associated with the invention are directed to means for interconnecting together various elements of the support structure in accordance with the invention, with the TV or other electronic apparatus itself. In particular, and as previously described herein, issues often arise with respect to components associated with the structure for attachment of supporting elements to the TV or other electronic apparatus. Known TV support structures often use connection means including screws, nuts/bolts combinations, and the like for connecting brackets associated with the TV itself to components of the support structures. In accordance with certain concepts of the invention, quick release features are associated with particular structures, so as to facilitate connection and removal of TVs or other electronic apparatus from the support structures themselves.

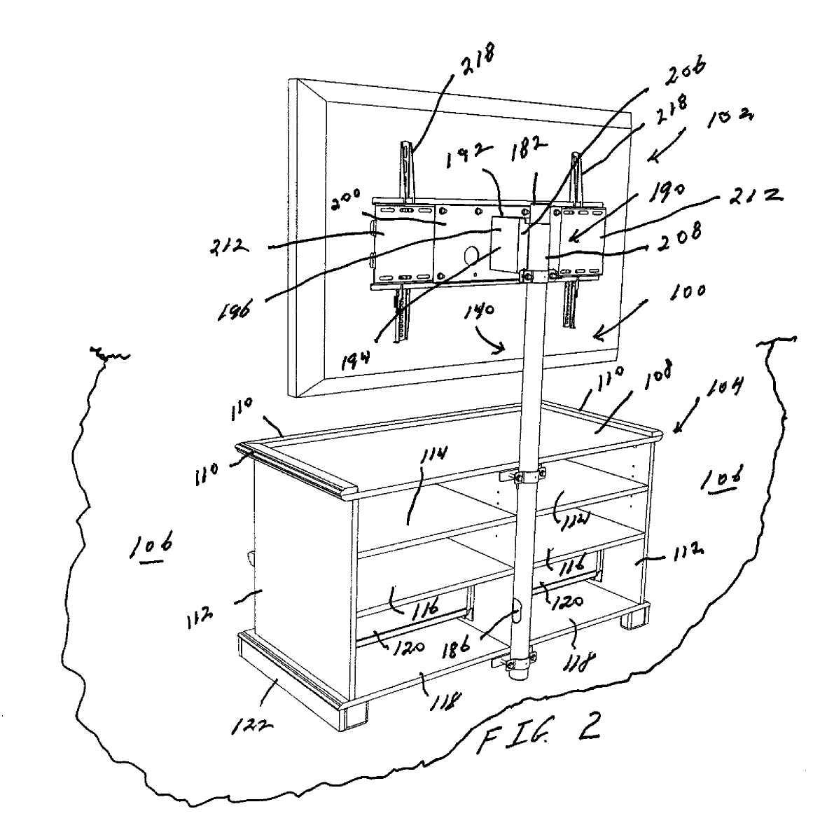

Turning first to FIGS. 1 and 2, a TV support structure 100 is shown therein with a conventional flat panel or similar TV 102 supported thereby. As further shown in FIGS. 1 and 2, the TV support structure 100 is associated with a furniture component shown as a conventional furniture cabinet 104. The cabinet 104 rests on a floor structure 106. The furniture cabinet 104 may be any of a number of different types of cabinets. In this particular embodiment, the cabinet 104 is shown as having an upper section or surface 108. The upper surface 108 is surrounded on three sides by a front rail and a pair of side rails 110. Extending downwardly from opposing sides of the upper section 108 are a pair of side panels 112. Further, in this particular embodiment of a furniture cabinet 104, the cabinet 104 includes a pair of inner top shelves 114. The inner top shelves 114 could be in the form of slidable shelves which could be extended or retracted, and adapted to hold electronic equipment such as DVD players and the like. The top shelves 114 may also be adjustable in height. Correspondingly, the cabinet 114 can include a series of inner middle shelves 116. Again, the middle shelves 116 could be adjustable in height and could also have a slidable feature.

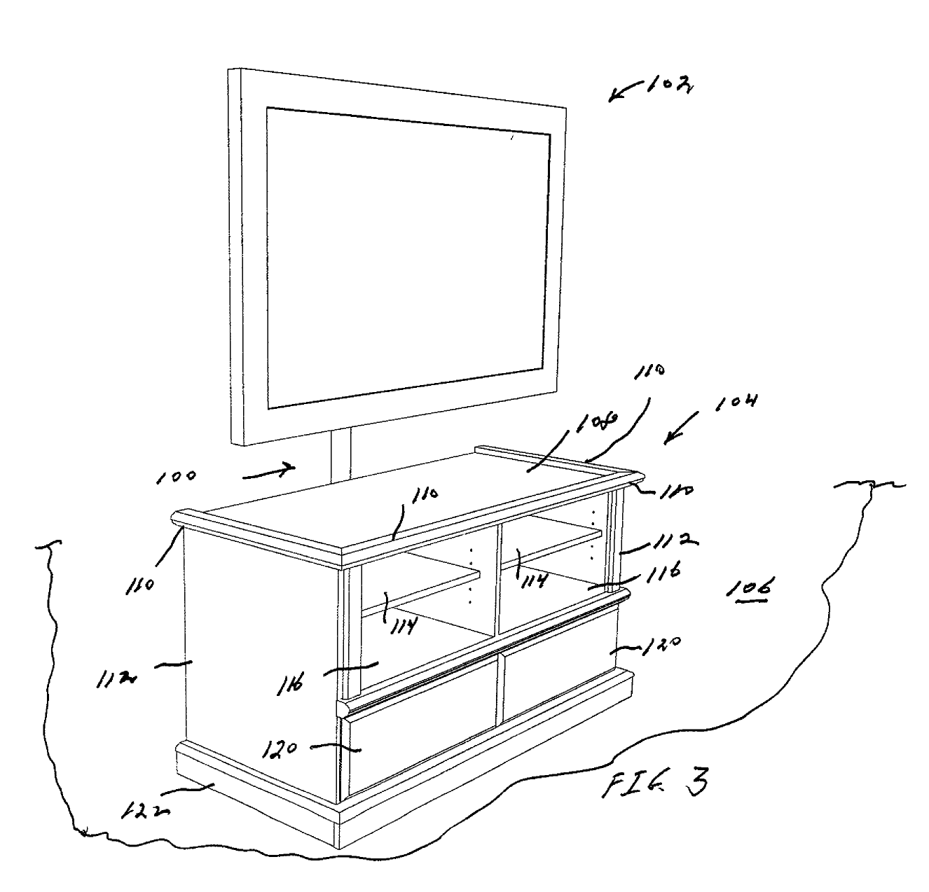

As shown in FIGS. 1 and 2, the furniture cabinet 104 can include a bottom 118. In addition, as shown in the front, perspective views of the cabinet 104 in FIGS. 3 and 4, the cabinet 104 may also include a pair of drawers 120. Also, the cabinet 104 can be supported by a three-sided base 122, as shown in each of FIGS. 1-4.

FIGS. 1-4 show an example furniture cabinet 104 which may be utilized with a TV support structure 100 in accordance with the invention. However, it should be emphasized that various types of furniture cabinets, or other structures, may be utilized with TV support structures in accordance with the invention, without in any manner departing from the spirit and scope of the novel concepts of the invention.

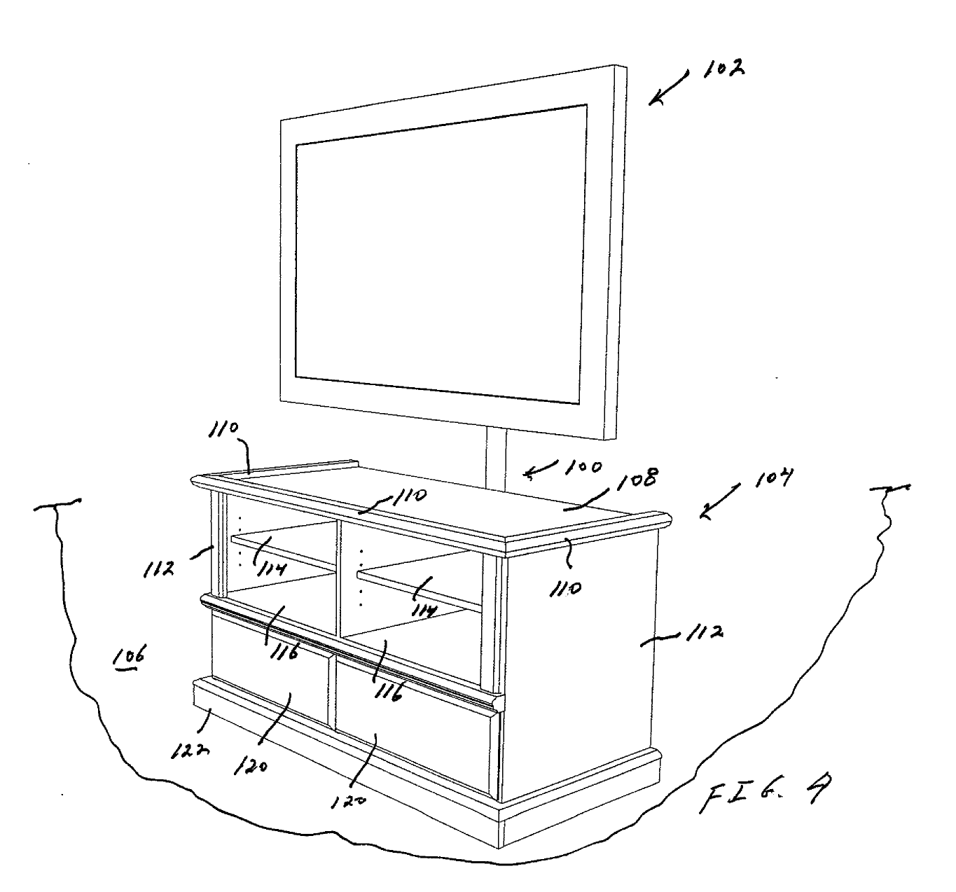

Turning to specific elements of the TV support structure 100, the support structure includes a post support assembly 140 as generally shown in FIGS. 1 and 2. In particular, details regarding the post support assembly 140 are particularly illustrated in FIGS. 5 and 8. With reference thereto, and with FIG. 5 illustrating a perspective and exploded view of the entirety of the TV support structure 100 and, in particular, the post support assembly 140, the assembly 140 includes a vertically disposed and elongated hollow post 142. The post 142 can be of any suitable material, including relatively lightweight metals. In addition to the elongated post 142, the assembly 140 also includes a vertical support clamp assembly 144. When assembled, the vertical support clamp assembly 144 will capture the post 142 and will be positioned immediately below a swivel bracket assembly described in subsequent paragraphs herein. The support clamp assembly 144 will act so as to support the swivel bracket assembly on the top of the clamp assembly 144.

More specifically, and primarily with respect to FIG. 5, the vertical support clamp assembly 144 includes an outer clamp 146 adapted to be positioned on one side of the post 142, with an inner clamp 148 positioned on the opposing side. For purposes of describing other features associated with the support structure 100 in subsequent paragraphs herein, it is noted at this time that the inner clamp 148 (as well as the outer clamp 146) includes a pair of inner clamp tabs 150. The clamp tabs 150 include apertures 151 through which a pair of bolts 152 are received. The bolts 152 and the associated clamps 146, 148 are tightened around the post 142 through the use of washer nuts 154. It should be noted that in accordance with certain concepts of the invention, the vertical support clamp assembly 144 provides the feature that the assembly 144 can be positioned anywhere along a continuum of the outer surface of the post 142. In this way, essentially “infinite” positions are available for positioning the clamp assembly 144 and, as will be apparent from the subsequent description herein, the TV 102.

Positioned below the vertical support clamp assembly 144, and capable of positioning along the post 142 at a desired height, is an intermediate support clamp assembly 156. The intermediate support clamp assembly 156 is shown in relative detail in both FIGS. 5 and 8. With reference thereto, the intermediate support clamp assembly 156 includes an outer clamp 158 adapted to be secured around the post 142. Positioned on the opposing side of the post 142 is an L-shaped support bracket 160. The intermediate support clamp assembly 156 is adapted to provide the capability of enhancing support rigidity through securing of the post 142 to structural portions of the furniture cabinet 104. For this purpose, the L-shaped support bracket 160 includes a vertical flange 162 extending across the width of the bracket 160. Integral with or otherwise connected to the vertical flange 162 are a pair of horizontal connecting tabs 164 (only one of the tabs 164 being shown in FIG. 8). For purposes of securing the outer clamp 158 to the L-shaped support bracket 160, a pair of threaded bolts 166 can be received through apertures 167 of the outer clamp 158 and through threaded apertures 168 cooperatively positioned in the vertical flange 162. As further shown in FIGS. 5 and 8, the horizontal connecting labs 164 include a series of threaded apertures 170. Screws or similar means can be used to secure the tabs 164 to the surface 108.

In addition to the intermediate support clamp assembly 156, the TV support structure 100 and the post support assembly 140 can include a lower support clamp assembly 172. Again, the lower support clamp assembly 172 is primarily shown in FIGS. 5 and 8. The lower support clamp assembly 172 is adapted to be interconnected to structural portions of the furniture cabinet 104 (or other structures) near the lower portion of the post 142. With reference primarily to FIG. 5, the lower support clamp assembly 172, as with the intermediate support claim assembly 156, can include an outer clamp 158. The outer clamp 158 is positioned on one side of the lower portion of the post 142. Also, as with the intermediate support claim assembly 156, the lower support clamp assembly 172 also includes an L-shaped support bracket 160. The lower L-Shaped support bracket 160 includes a vertically disposed flange 162. Integral with or otherwise connected to the vertical flange 162 are a pair of horizontal connecting tabs 164. With this configuration, apertures 167 can be positioned on opposing tab sides of the outer clamp 158. Threaded bolts 166 can be received through the apertures 167. Correspondingly, a pair of threaded apertures 168 are located in and through the vertical flange 162 of the L-shaped support bracket 160. These apertures 168 are also adapted to receive the threaded bolts 160, thereby securing the lower support clamp assembly 172 to the lower portion of the post 142. Also, as with the horizontal connecting tabs 164 associated with the intermediate support clamp assembly 156, the connecting tabs 164 associated with the lower support clamp assembly 172 include sets of threaded apertures 170 received therethrough.

FIG. 8 is an underside, perspective and partial view of the post support assembly 140, showing the intermediate support clamp assembly 156 and the lower support clamp assembly 172 as connected to the structural portions of the furniture cabinet 104. More specifically, and again with reference to FIG. 8, the intermediate support clamp assembly 156 is shown as coupling the post 142 to the lower surface of the upper section 108 of the furniture cabinet 104. With this connection, the outer clamp 158 is secured to the L-shaped support bracket 160 through the threaded bolts 166, which extend through the apertures 167 of the clamp 158 and the threaded apertures 168 of the vertical flange 162. Correspondingly, the L-shaped support bracket 160 is connected to the bottom of the upper section 108 through a set of screws 174 which are received through the threaded apertures 170.

An identical connection of the post 142 to structural portions of the furniture cabinet 108 is made through the use of the lower support clamp assembly 172. Again, with reference to FIG. 8, the outer clamp 158 of the lower support clamp assembly 172 is connected to the L-shaped support bracket 160 through threaded bolts 166 which extend through apertures 167 of the outer clamp 158 and threaded apertures 168 of the vertical flange 162. Correspondingly, the horizontal connecting tabs 164 of the support bracket 160 are secured to the lower surface of the bottom 118 of the furniture cabinet 104 through the screws 174 which extend through threaded apertures 170 of the connecting tabs 164.

It should be emphasized that if desired, the outer clamp 158 and the L-shaped support brackets 160 of both the intermediate support clamp assembly 156 and the lower support clamp assembly 172 can be substantially tightened against the post 142. However, and in accordance with certain concepts of the invention, the amount of tightening pressure exerted by the clamp assemblies 156 and 172 can be such so as to permit the post 142 to actually rest on the floor structure 106 or a similar surface. In this manner, a substantial portion of the weight of the TV 102 is transferred from the support structure 100 itself to the floor structure 106.

In addition to various features previously described herein, the TV support structure 100 also includes, in accordance with certain concepts of the invention, a wire management assembly 180, primarily shown in FIGS. 1, 2, and 5-7. More specifically, the wire management assembly 180 provides for the capability of utilizing hidden pathways within the TV support structure 100 to hide and provide a safe path of travel for various wires and cables which may be associated with the TV 102, other electronic devices which may be supported on the furniture cabinet 104, and cables which provide external sources of electrical power. The wire management assembly 180 may also provide for various cables associated with data and communications.

The management assembly 180 can be characterized as utilizing the post 142, with an upper grommet 182 positioned at the top of the post 142. The upper grommet is shown in FIGS. 1, 2, and 5-7. As earlier described, the post 142 can include a hollow interior chamber, illustrated as hollow channel 184 in FIGS. 1, 5, and 7. Extending laterally outwardly at an appropriate location along the lower outer surface of the post 142 is a lower grommet 186. The lower grommet 186 is illustrated in FIGS. 2, 5, and 6, and provides an external opening within the post 142. Cabling, such as the cable 188 illustrated in FIG. 6, can extend from the TV 102 through the upper grommet 182, downwardly through the hollow channel 184, and egress outwardly from the post 142 through the lower grommet 186. The lower grommet 186 is positioned so as to provide a convenient exit from the post 142 for connection to external power sources, external data and communications devices, and the like.

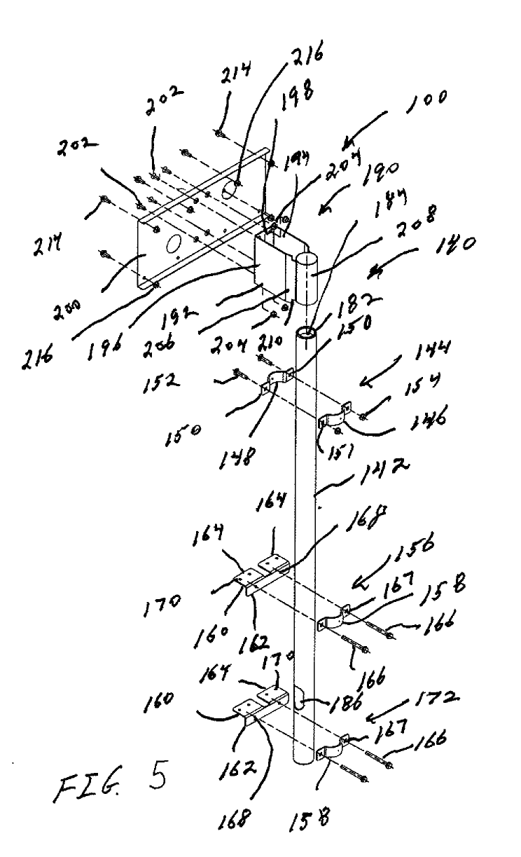

Another feature of the TV support structure 100 in accordance with certain concepts of the invention relates to the capability of the support structure 100 to provide for a swivel or rotation of the TV 102 along a substantially horizontal plane. To achieve this advantageous function, the support structure 100 includes a swivel assembly 190. The swivel assembly 190 is primarily shown in FIGS. 1, 2, 5-7, 9 and 10. With reference thereto, and particularly to FIGS. 5 and 7, the swivel assembly 190 includes a swivel bracket 192 which essentially interconnects structure associated with the TV 102 to the post support assembly 140. The swivel bracket 192 includes what can be characterized as a U-shaped box portion 194. The box portion 194 is essentially vertically disposed and opens outwardly toward the rear of the support structure 100. The box portion 194 includes a pair of vertically disposed and substantially rectangular bracket sides 196. Along one edge of each of the bracket sides 196, a web base 198 is integral with or otherwise connected to the bracket sides 196. The web base 198 is also vertically disposed. The web base 198 is secured to a connector plate 200 through any suitable connecting means, such as bolts 202 and nuts 204 (the bolts 202 and nuts 204 being primarily shown in FIG. 5).

At the rearwardly extending opening of the channel formed by the bracket size 196 and web base 198, a pair of inwardly angled sides 206 are integral with or otherwise connected to edges of the bracket sides 196. As shown again in particular in FIGS. 5 and 7, the inwardly angled sides 206 (only one of such sides being shown in FIG. 7) are secured to a vertically disposed post sleeve 208. The post sleeve may be integral with the edges of the inwardly angled sides 206, or otherwise secured to the post sleeve 208 through any suitable connecting means (preferably such as weldments or the like).

To assemble the swivel assembly 190 to the post support assembly 140, the vertical support clamp assembly 144 previously described herein can first be secured at a desired height on the post 142. The post sleeve 208 can then be received on and around the post 142 from the top portion of the post 142. The post sleeve 208 is sized so as to rest on the outer clamp 146 and inner clamp 148 of the clamp assembly 144. With this configuration, it should be noted that the inwardly angled sides 206 of the swivel bracket 192 include a pair of lower notches 210. The notches 210 are primarily shown in FIGS. 5, 6, and 7, although each of the illustrations shows only one of the lower notches 210.

To further describe the features of the swivel assembly 190 and the functional operation thereof, reference is made to FIGS. 1, 2, 6, 7, 9, and 10. These drawings illustrate a substantially rectangular and elongated wall plate 212. The connector plate 200 is connected to the wall plate 212 through the use of bolts 214 and nuts 216. The bolts 214 and nuts 216 are primarily shown in FIGS. 1, 2, and 7. In turn with respect to the connection between the connector plate 200 and the wall plate 212, the wall plate 212 is secured to a pair of mounting rails 218. The mounting rails 218 are first primarily shown in FIGS. 1 and 2. Also, certain features of the novel concepts of the invention relate to the releasable interconnections of the wall plate 212 to the mounting rails 218. These features will be described in FIGS. 11-18 in subsequent paragraphs herein. At this time, it is sufficient to state that the mounting rails 218 are secured to the wall plate 212 in any suitable manner, without departing from certain of the principles of the invention. Correspondingly, the mounting rails 218 can be secured directly to the rear of the TV 102, again by any suitable means.

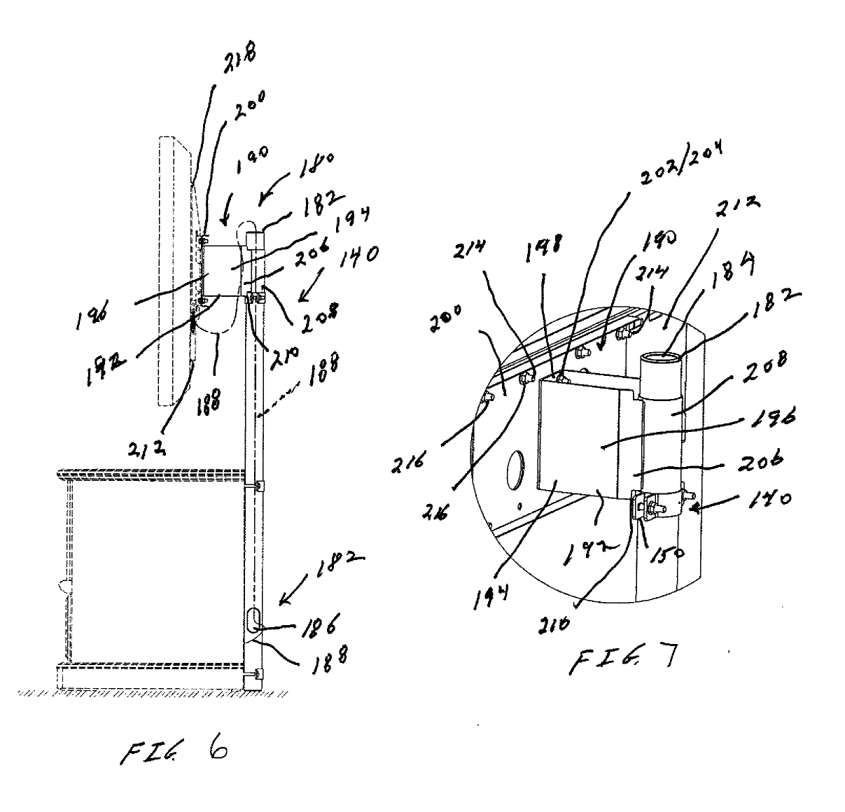

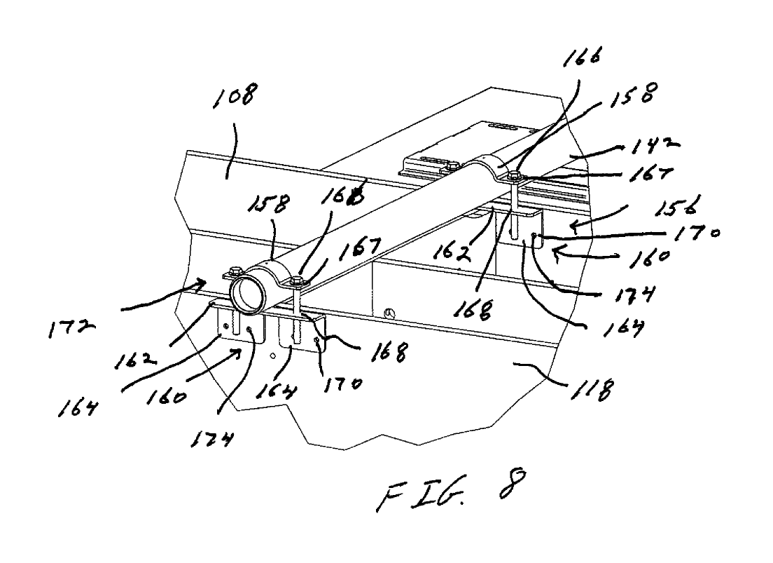

FIGS. 7, 9, and 10 particularly illustrate the functional operation of the swivel assembly 190. FIG. 9 is a plan view of the TV support structure 100 and interconnected TV 102, with the TV 102 having an orientation which can be characterized as a “normal” orientation, where the face of the TV 102 is directly perpendicular to an axis X as particularly shown in FIGS. 9 and 10. The axis X extends directly through the center of the swivel bracket 192 and the post 142. Correspondingly, the inner diameter of the post sleeve 208 is sufficiently greater than the outer diameter of the post 142, so that the post sleeve 208 and swivel bracket 192 are permitted to rotate in a horizontal plane. FIG. 10 illustrates the TV 102 rotated a sufficient distance away from a normal orientation to axis X, with the rotation being through an angle A. In this orientation, an axis S is perpendicular to the face of the TV 102. It should be emphasized, and also apparent, that with the configuration of the post sleeve 208 and the swivel bracket 192, the TV 102 can also be rotated in a direction opposing the direction shown in FIG. 10.

This feature of rotation along a horizontal plane provides the user with the capability of adjusting the TV 102 so that the face of the same is angled relative to normal, for purposes of facilitating different viewing locations. However, if the rotation is too extensive, the movement of the TV 102 can cause damage to walls or other furniture articles. To provide for the capability of limiting the angular rotation which may be achieved, attention is again drawn back to the notches 210 which exist at the bottom portions of the inwardly angled sides 206 of the swivel bracket 192. As shown primarily in FIGS. 7 and 10, if the rotational angle of the TV 102 increases to a predetermined and “maximum” threshold angle, the vertical edge of one of the lower notches 210 will abut a corresponding one of the inner chimp tabs 150 associated with the vertical support clamp assembly 144. This maximum angle is shown in FIG. 10, with the abutment occurring at the location identified in FIG. 10 as location 220. This limiting feature prevents angular movement of the TV 102 beyond the threshold angle, so as to avoid damaging other furniture articles, or causing the TV 102 to move to what could be a potentially dangerous orientation.

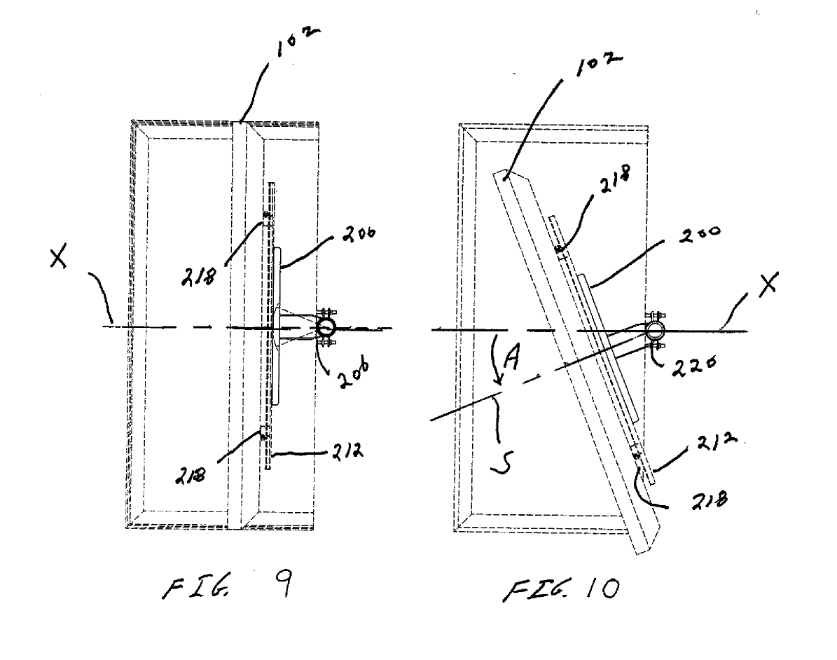

In addition to the features of the TV support structure 100 previously described herein in accordance with the invention, another feature in accordance with certain concepts of the invention is directed to the capability of securing the TV support structure 100 to the TV 102 in a manner which facilitates both coupling and release of the relative structures. This advantageous feature is provided by a latch assembly 230 which is utilized to releasably couple the wall plate 212 to the mounting rails 218. The latch assembly 230 will be described primarily with respect to FIGS. 11-18. With reference thereto, the latch assembly 230 includes a pair of release latch mechanisms 232. One of the release latch mechanisms 232 will be associated with one of the mounting rails 218, while the other release latch mechanism 232 will be associated with the other mounting rail 218. Each of the release latch mechanisms 232 can be considered to be a “mirror image” of the other of the release latch mechanisms 232. The release latch mechanism 232 which is shown in FIGS. 11 and 12 to be associated with the mounting rail 218 position on the “right side” of each of the drawings will be the particular release latch mechanism 232 described in subsequent paragraphs herein primarily with respect to FIGS. 13-18.

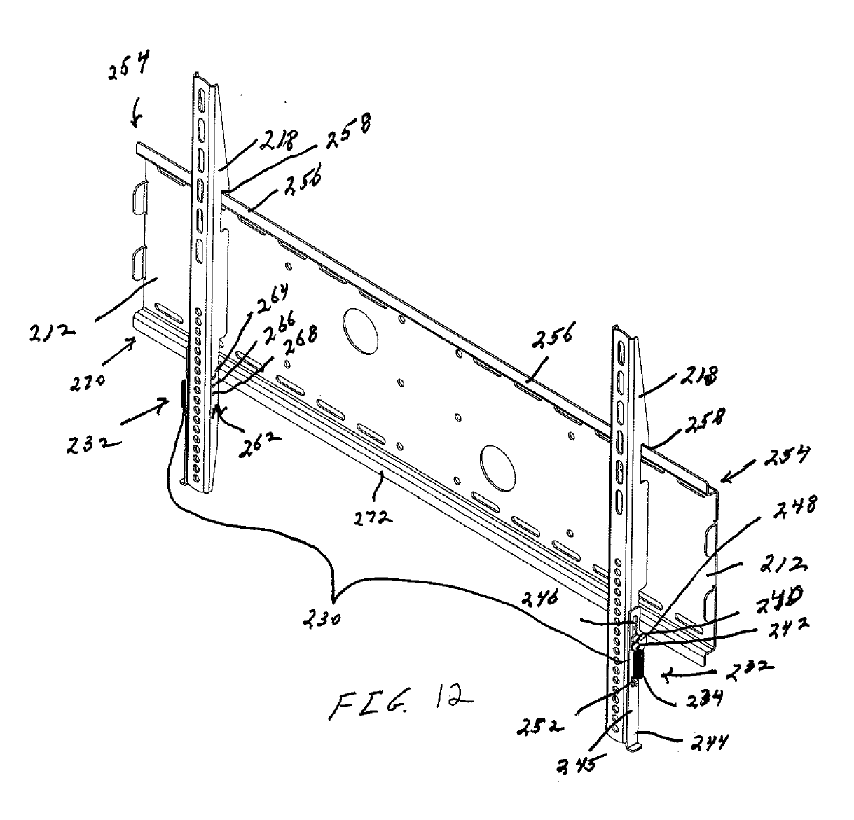

Each of the release LATCH mechanisms 232 includes an elongated and vertically disposed coil spring 234. One of the springs 234 is shown in each of FIGS. 11-18. As shown primarily in FIGS. 15 and 16, the coil spring 234 includes an upper circular hook 236 and a lower circular hook 238. Each release latch mechanism 232 also includes a pair of screws, identified particularly in FIGS. 13-18 as including an upper screw 240 and a lower screw 242. The screws 240, 242 are used in association with a pair of washers 243, also primarily shown in FIGS. 15 and 16. The lower screw 242, as described in more detail in subsequent paragraphs herein, is adapted to be received through the upper hook 236 of the coil spring 234.

Each of the release latch mechanisms 232 also includes a component which could be described as a latch bar 244. One of the latch bars 244 is shown in each of FIGS. 11-18. Each latch bar 244 includes an elongated and vertically disposed body 245. At an upper portion of the elongated body 245, a vertically disposed and elongated adjustment channel 246 is positioned. The elongated adjustment channel 246 is particularly shown in FIG. 15. As further described in subsequent paragraphs herein, each of the screws 240, 242 are also adapted to be received through the adjustment channel 246.

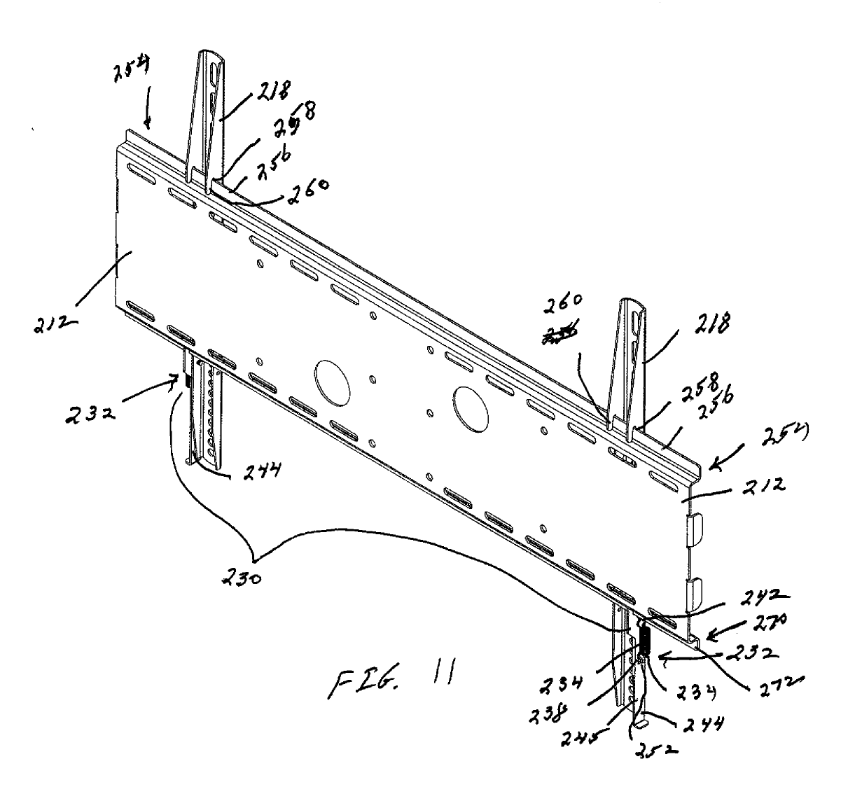

Extending laterally from the opposing faces of the elongated body 245 of the latch bar 244 is an offset flange 248 having the shape and configuration primarily shown in FIGS. 14, 15 and 18. The offset flange 248 can be integral with or otherwise connected to the elongated body 245. The flange 248 extends laterally from the elongated body 245 in a direction rearward of the connections of the mounting rails 218 to the TV 102. Each of the offset flanges 248 includes an element which can be characterized as a catch slot 250. The catch slot 250 for one of the release latch mechanisms 232 is particularly shown in FIGS. 13, 14 and 15. Each catch slot 250 is a three-sided slot which opens upwardly from the offset flange 248. As will be described in subsequent paragraphs herein in greater detail, the catch slots 250 are adapted to releasably receive elements of the wall plate 212, so as to releasably secure the wall plate 212 to the rails 218. The remaining component of the release latch mechanism 232 is a lower spring catch 252 which is secured to one face of the elongated body 245 and extends downwardly in an arcuate shape therefrom. When assembled, the lower spring catch 252 is adapted to releasably couple the spring 234 thereto, through the lower spring hook 238.

The foregoing describes the various elements of the latch assembly 230 and each of the release latch mechanisms 232. For purposes of functional operation of the latch assembly 230, the wall plate 212 and the mounting rails 218 include certain other elements. Marc specifically, and with reference primarily to FIG. 15, extending outwardly from outer sides of each of the mounting rails 218 are a series of three apertures 262, having a vertically disposed orientation. The apertures 262 can be characterized as including an upper aperture 264, middle aperture 266 and lower aperture 268. The apertures are preferably threaded. In use and when the latch assembly 230 is completely assembled, the upper screw 240 and the lower screw 242 are adapted to be threadably received within two selected ones of the apertures 262.

In addition to the foregoing, the wall plate 212 includes an elongated upper L-shaped flange 254. The flange 254 is particularly shown in FIGS. 11 and 12. The L-shaped flange 254 includes an upper vertical leg 256. Correspondingly, and again as primarily shown in FIGS. 11 and 12, the mounting rails 218 each include a pair of upper rail slots 258 formed in opposing sides of the upper portions of each of the rails 218. At the upper portion of each of the upper rail slots 258, an upper rail lip 260 is formed. Each of the upper rail lips 260 projects downwardly and forms a “capturing” area at the upper portion of each of the upper rail slots 258. To initially assemble the wall plate 212 to the mounting rails 218, the wall plate 212 can be positioned so that the upper rail lips 260 essentially overhang the upper vertical leg 256 of the wall plate 212. This configuration is also shown in FIGS. 11 and 12. In this manner, the upper portion of the wall plate 212 is releasably captured by the mounting rails 218.

With further reference to substantially all of FIGS. 11-18, the wall plate 212 further includes a lower L-shaped flange 270. The lower L-shaped flange 270 is particularly shown in cross section in FIG. 14. The lower L-shaped flange 270 includes a downwardly disposed lower vertical leg 272. As further described herein, when the latch assembly 230 releasably secures the wall plate 212 to the mounting rails 218, the lower vertical leg 272 is captured within each of the catch slots 250 of each of the release latch mechanisms 232.

The releasable assembly of the wall plate 212 to the mounting rails 218, using the latch assembly 230, will now be described with respect to FIGS. 11-18. For each of the release latch mechanisms 232, the latch bar 244 is positioned in an abutting relationship with the outer side of the corresponding mounting rail 218. One of the washers 243 can then be positioned between the elongated body 245 of the latch bar 244 and the upper hook 236 of the coil spring 234. The lower screw 242 can then be received through the upper spring hook 236 and through the washer 243. The lower screw 242 can then be further received through the elongated adjustment channel 246 of the latch bar 244. The screw 242 can then be threadably received through either the middle aperture 266 or the lower aperture 268 positioned in the outer side of the corresponding mounting rail 218. In the particular assembly shown in FIGS. 13-18, the lower screw 242 is threadably received through the lower aperture 268. In this manner, the upper part of the coil spring 234 is secured to the latch bar 244 and to the corresponding mounting rail 218.

The lower hook 238 of the coil spring 234 can then be releasably coupled to the lower spring catch 252 positioned on a side of the elongated body 245. This configuration is shown in several of the drawings, including FIGS. 14 and 18. The upper screw 240 and associated washer 243 can then be received through the elongated adjustment channel 246 (above the lower screw 242), and then further threadably received through either the upper aperture 264 or the middle aperture 266. In the particular embodiment shown in FIGS. 13-18, the upper screw 240 is received through the middle aperture 266. If, on the other hand, the upper screw 240 was received through the upper aperture 264, then proper assembly of the release latch mechanism 232 would preferably include threadable insertion of the lower screw 242 through the middle aperture 266, rather than the lower aperture 268.

For proper operation, the relationship between the screws 240, 242 and the elongated body 245 with the latch part 244 should be such that the screws 240, 242 are free to move within the elongated adjustment channel 246. Stated in another manner, although the screws 240, 242 remain stationary in view of the threadable connections to the associated mounting rail 218, the latch bar 244 should be free to move vertically upwardly and downwardly, subject to the limitations of the length of the elongated adjustment channel 246.

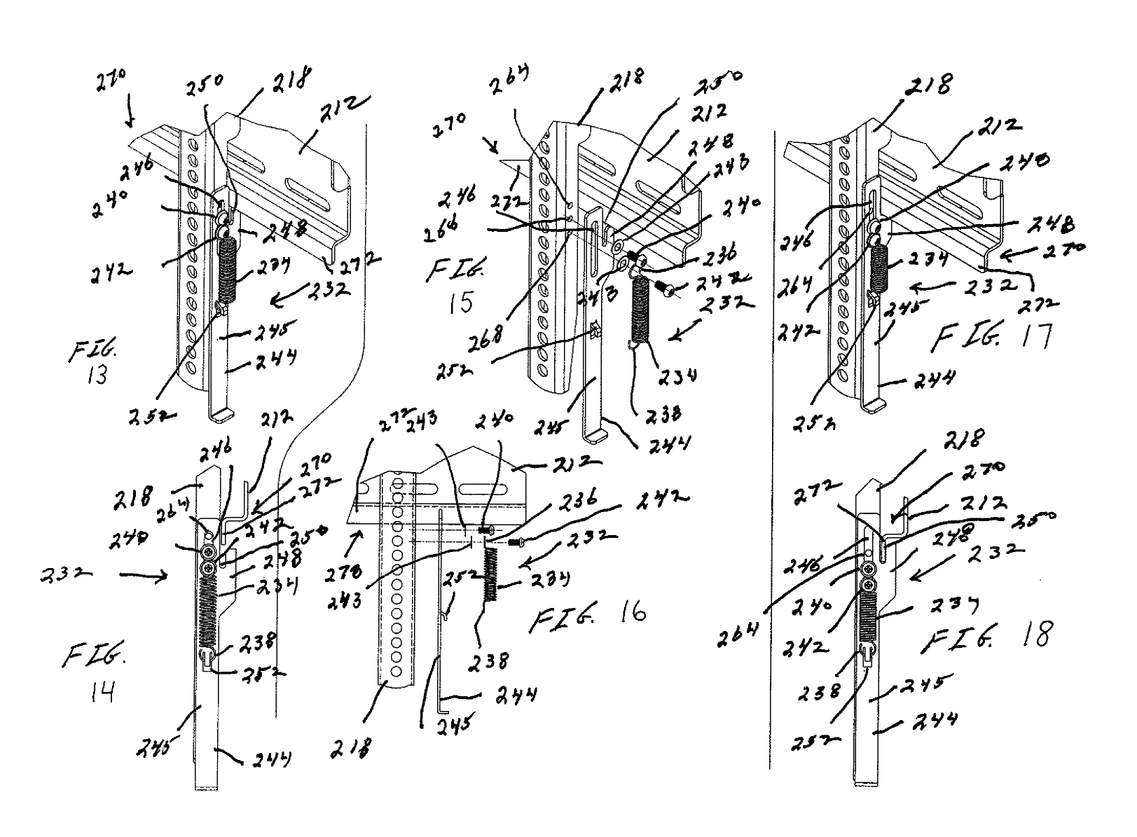

The various elements of each of the release latch mechanisms 232 should be sized and configured so that each mechanism 232 is in the position shown in FIGS. 17 and 18, relative to the associated mounting rail 218, when there is an absence of any external forces applied to the latch bar 234. This position is characterized as the “latched” or “closed” position of the latch mechanism 232. In this position, and again with appropriate sizing, the lower vertical leg 272 of the lower L-shaped flange 270 is captured within the catch slot 250. For this configuration, the coil spring 234 should be appropriately sized and configured so that it is in a tensioned state when in the configuration shown in FIGS. 17 and 18, with the mechanism 232 in a closed position. With the spring 234 in a tensioned state, the lower screw 242 capturing the upper hook 236, the lower spring catch 252 capturing the lower hook 238 of the spring 234, and further with the lower screw 242 remaining stationary, forces will be exerted on the latch bar 244 (through the lower hook 238 and catch 252) so as to tend to move the latch bar 244 upwardly, relative to the corresponding mounting rail 218. The upwardly directed forces exerted by the spring 234 will cause the lower vertical leg 272 to remain captured within the catch slot 250, absent any externally applied forces.

When it is desired to remove the wall plate 212 from the mounting rails 218, a user can grip the elongated body 245 of the latch bar 244, and exert downwardly extending forces thereon. The downwardly extending forces will cause the latch bar 244 to move downwardly, relative to the associated mounting rail 218. These forces need to be sufficient so as to overcome the tensioning forces exerted by the spring 234. With sufficient downwardly applied force, the elongated body 245 will move sufficiently so that the catch slot 250 is no longer capturing the lower vertical leg 272 of the lower L-shaped flange 270. This relative configuration of each of the release latch mechanisms 232 is referred to as one where the latch assembly 230 is in an “open” position. In this open position, the wall plate 212 can be removed from the mounting rails 218. A release of externally applied forces from the latch bar 244 will cause the latch bar 244 to return to the position shown in FIGS. 17 and 18, as a result of the forces exerted by the coil spring 234 on the spring catch 252 which result from the tendency of the spring 234 to want to contract.

The foregoing has completely described the functional and advantageous operation of the latch assembly 230 in accordance with the invention. However, it should be emphasized that FIGS. 11-18 show only one embodiment of a latch assembly in accordance with the invention. Various other configurations of springs, latch bars and associated elements could be utilized, without departing from the principal concepts of the invention.

Also, as previously described, the mounting rails 218 include, in this embodiment, an upper aperture 264. The upper aperture 264 was not used in the embodiment described herein. However, if a slightly different configuration was to be utilized, or if the wall plate 212 was of a shorter height, or if the lower vertical leg 272 was of a shorter length, the upper screw 240 could be threadably received within the upper aperture 264. Correspondingly, the lower screw 242 could be threadably received within the middle aperture 266. This would cause the latch bar 244 to be in a relatively higher position when in the closed configuration illustrated in FIGS. 17 and 18.

It will be apparent to those skilled in the pertinent arts that other embodiments of TV support structures and latch mechanisms in accordance with the invention can be designed. That is, the principles of support structures and latch mechanisms in accordance with the invention are not limited to the specific embodiments described herein. Accordingly, it will be apparent to those skilled in the art that modifications and other variations of the above-described illustrative embodiments of the invention may be effected without departing from the spirit and scope of novel concepts of the invention.

1. A support structure for supporting electrical apparatus and adapted to be rested on a floor surface, said support structure comprising:
a post support assembly having a vertically disposed and elongated hollow post, and a vertical support clamp assembly, said vertical support clamp assembly capturing the post;
a swivel bracket assembly positioned immediately above said vertical support clamp assembly;
an intermediate support clamp assembly for positioning said post at a desired height, and including an outer clamp adapted to be secured around said post, along with an L-shaped support bracket;
a lower support clamp assembly interconnected to structural portions of a furniture structure near a lower portion of said post, said lower support clamp assembly having an outer clamp position on one side of said post, and an L-shaped support bracket having a vertically disposed flange; and
a pair of horizontal connecting tabs integral with or otherwise connected to said vertical flange.
